(19) United States
(12) Patent Application Publication
(10) Pub. No.: US 2013/0277902 A1
(43) Pub. Date: Oct. 24, 2013

(54) Worktable Assembly With A Magnetic Workpiece Support

(71) Applicant: Chin-Chi Lin, Taichung City (TW)

(72) Inventor: Chin-Chi Lin, Taichung City (TW)

(21) Appl. No.: 13/482,169

(22) Filed: May 29, 2012

(30) Foreign Application Priority Data
Apr. 20, 2012 (TW) 101207426

(51) Int. Cl. B25B 11/00

(52) U.S. Cl. 269/8

(57) ABSTRACT

A worktable assembly adapted to be disposed with a workpiece thereon includes a table top with a magnetically attractive top surface, and a workpiece support which includes a plurality of magnetic support pads disposed on the top surface and magnetically attracted to the top surface. The magnetic support pads have upward support surfaces extending along a horizontal plane for contacting the workpiece.

### CROSS-REFERENCE TO RELATED APPLICATION

This application claims priority of Taiwanese Application No. 101207426, filed on Apr. 20, 2012.

### BACKGROUND OF THE INVENTION

1. Field of the Invention

The invention relates to a worktable assembly, more particularly to a worktable assembly having a magnetic workpiece support for supporting a workpiece.

2. Description of the Related Art

U.S. Pat. No. 6,068,543 discloses a conventional worktable for performing machining operations on a workpiece using a tool. The conventional worktable includes a base, a table mounted on the base, and an elevator mechanism mounted on the base and installed with a machining tool. In use, a workpiece is placed on the table and is moved manually by an operator for performing machining operations on the workpiece. The workpiece typically has a bottom side in close contact with the table. In the case where the workpiece has a different configuration, for example, a projecting rim or a non-planar bottom side, the workpiece might tilt on the worktable and may not be moved stably on the worktable. Hence, such kinds of workpieces cannot be well supported on the worktable, resulting in difficulties when performing the machining operations.

### SUMMARY OF THE INVENTION

Therefore, the object of the present invention is to provide a worktable assembly that can alleviate the abovementioned drawbacks of the prior art and that is suitable for use with workpieces of various configurations.

Accordingly, a worktable assembly of the present invention adapted to be disposed with a workpiece thereon includes a table top and a workpiece support. The table top has a magnetically attractive top surface. The workpiece support includes a plurality of magnetic support pads disposed removably on and magnetically attracted to the top surface of the table top. Each of the magnetic support pads has an upward support surface for contacting the workpiece. The support surfaces of the magnetic support pads extend along a horizontal plane when the magnetic support pads are disposed on the top surface of the table top.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a preferred embodiment of a worktable assembly according to the present invention;

FIG. 2 is a partly-exploded perspective view of the preferred embodiment shown in FIG. 1;

FIG. 3 is a cross-sectional view taken along line III-III in FIG. 1;

FIG. 4 is a fragmentary, partly exploded perspective view showing the preferred embodiment before mounting of a workpiece and a tool;

FIG. 5 is a perspective view of the preferred embodiment when mounted with the workpiece and the tool;

FIG. 6 is a fragmentary top view of FIG. 5, showing relative positions between a workpiece and a workpiece support; and

FIG. 7 is a fragmentary sectional view of FIG. 5, showing the workpiece supported by the workpiece support.

### DETAILED DESCRIPTION OF THE PREFERRED EMBODIMENT

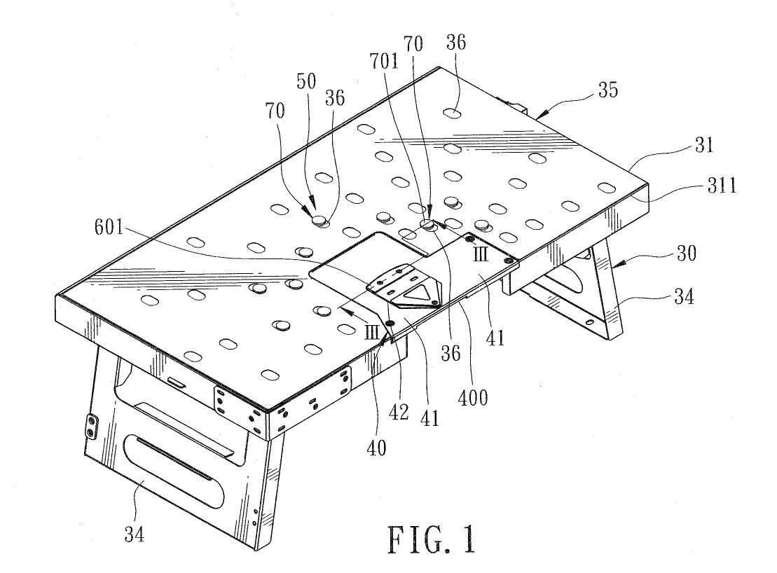

As shown in FIG. 1, the preferred embodiment of a worktable assembly according to the present invention includes a table unit 30, a positioning plate 35, a mounting unit 40 and a workpiece support 50.

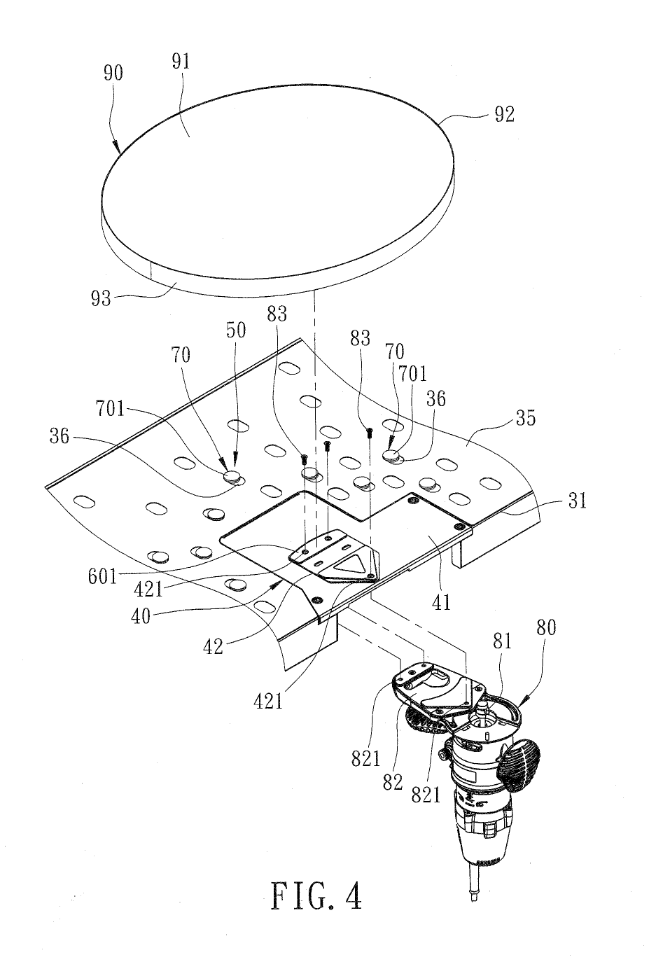

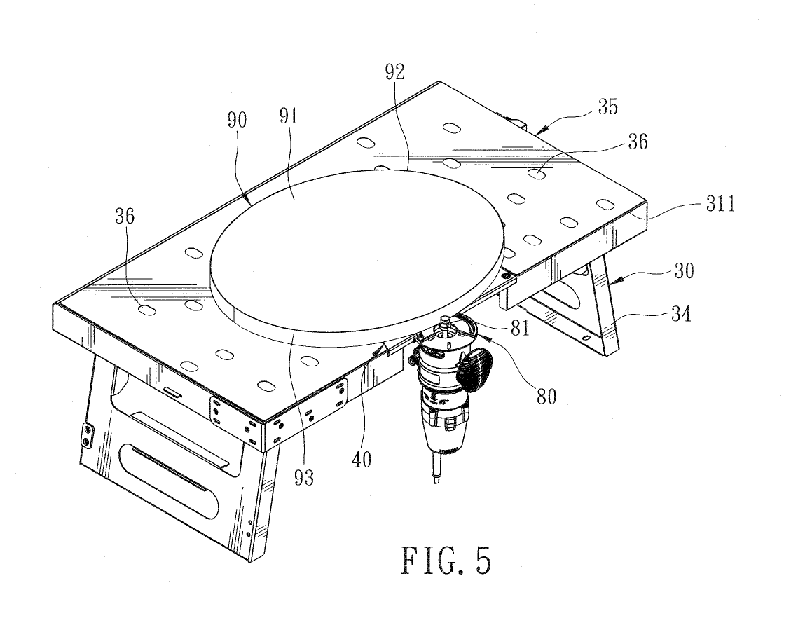

As shown in FIGS. 4 and 5, the worktable assembly of the preferred embodiment is adapted to be mounted with a machining tool 80 for performing machining operations on a workpiece 90 which is to be supported on the worktable assembly. The machining tool 80 may be, for example, a chamfering machine with a blade 81. The workpiece 90 is, for example, a plate material having a central portion 91, an edge portion 92, and an edge band 93 adhered to and projecting from the edge portion 92.

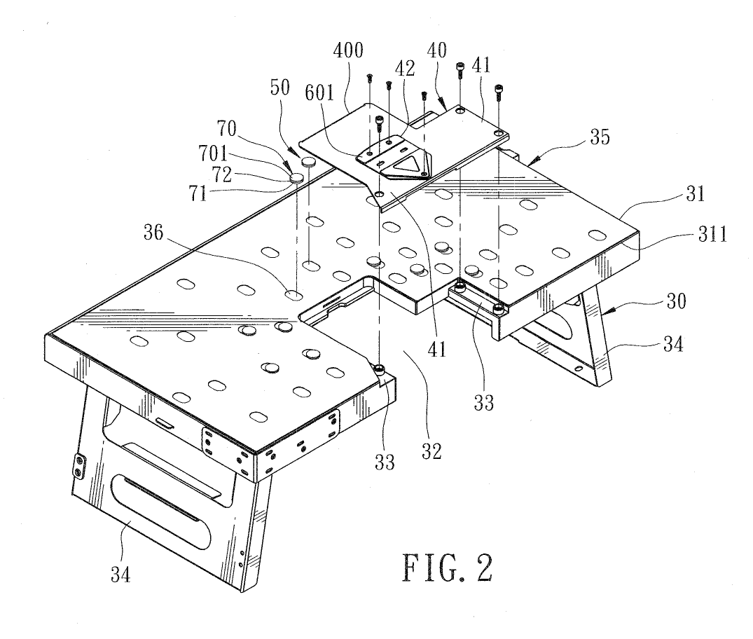

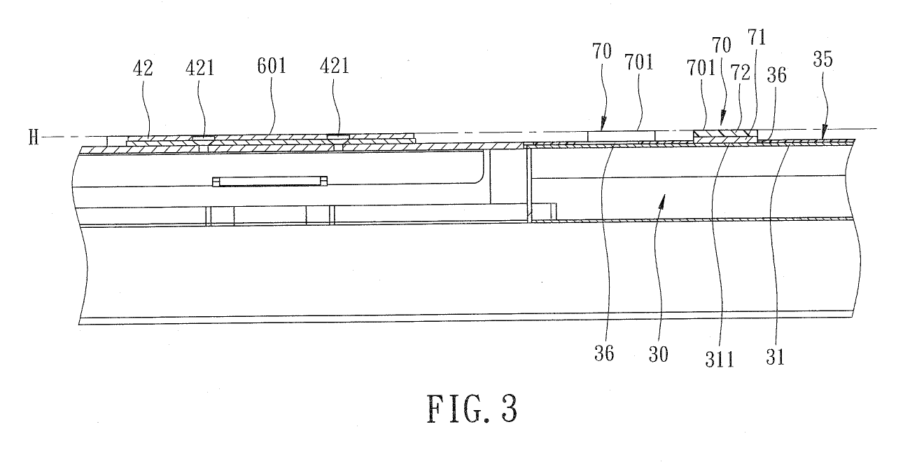

As shown in FIGS. 1 to 3, the table unit 30 includes a table top 31 with a flat, magnetically attractive top surface 311, and a pair of foldable legs 34 mounted to a bottom side of the table top 31. The table top 31 is formed with a mounting cavity 32 and a plurality of fastening blocks 33 adjacent to the mounting cavity 32.

The positioning plate 35 is attached securely to the top surface 311, and is formed with a plurality of elongated positioning holes 36. In the present embodiment, the positioning plate 35 is a plastic sheet.

The mounting unit 40 is disposed in the mounting cavity 32 of the table top 31, and includes a mounting plate 400 which has a plurality of side plate portions 41 fastened to the fastening blocks 33, and a connecting plate portion 42 interconnecting the side plate portions 41. As shown in FIG. 4, the connecting plate portion 42 is formed with a plurality of fastener holes 421 which fittingly receive screw heads. The tool 80 can be fastened onto the connecting plate portion 42 by means of a plurality of fastening screws 83 which are extended through the fastener holes 421 and are engaged with screw holes 821 provided in a fastening part 82 of the tool 80.

Referring back to FIGS. 1 to 3, the workpiece support 50 includes a plurality of magnetic support pads 70, each of which is to be disposed removably in a selected one of the positioning holes 36 in the positioning plate 35. Each of the magnetic support pads 70 includes a magnet layer 71 to be magnetically attracted to the top surface 311 of the table top 31, and a plastic abrasion resistant layer 72 secured to the magnet layer 71. Each of the magnetic support pads 70 has a thickness greater than that of the positioning plate 35. Each of the magnetic support pads 70 has an upward first support surface 701 formed on the abrasion resistant layer 72 for contacting the workpiece 90 (see FIGS. 4 and 5) disposed on the worktable assembly. The first support surfaces 701 of the magnetic support pads 70 extend along a horizontal plane (H) which is parallel to the positioning plate 35 and the top surface 311 of the table top 31. Since the positioning plate 35 is thinner than the magnetic support pads 70, the positioning plate 35 is disposed under the horizontal plane (H).

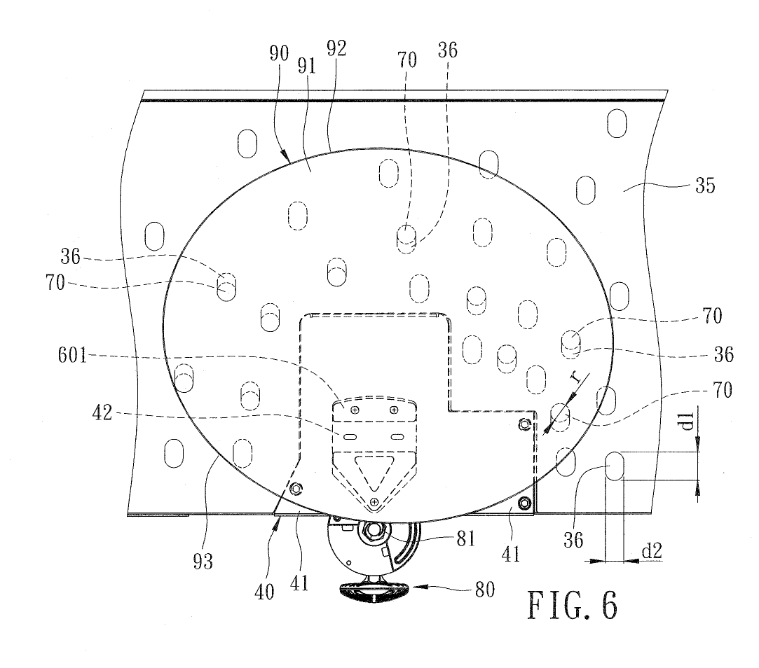

As shown in FIG. 6, each positioning hole 36 has a length, which is its longest diameter (d1), and a width, which is its shortest diameter (d2). Each of the magnetic support pads 70 has a greatest diameter which is smaller than the length (d1) of the positioning holes 36. As such, each magnetic support pad 70 can be moved manually along the length (d1) of the respective positioning hole 36 to permit fine adjustment of the position of the magnetic support pad 70 relative to the workpiece 90. In the present embodiment, the magnetic support pads 70 are circular in shape with a diameter (r) not greater than the width (d2) of the positioning holes 36.

Referring back to FIGS. 1 to 3, in the present embodiment, an upward second support surface 601 is formed on the connecting plate portion 42 of the mounting unit 40. The second support surface 601 extends along the horizontal plane (H) to assist in supporting the workpiece 90. In other embodiments, the second support surface 601 may be formed on the table top 31.

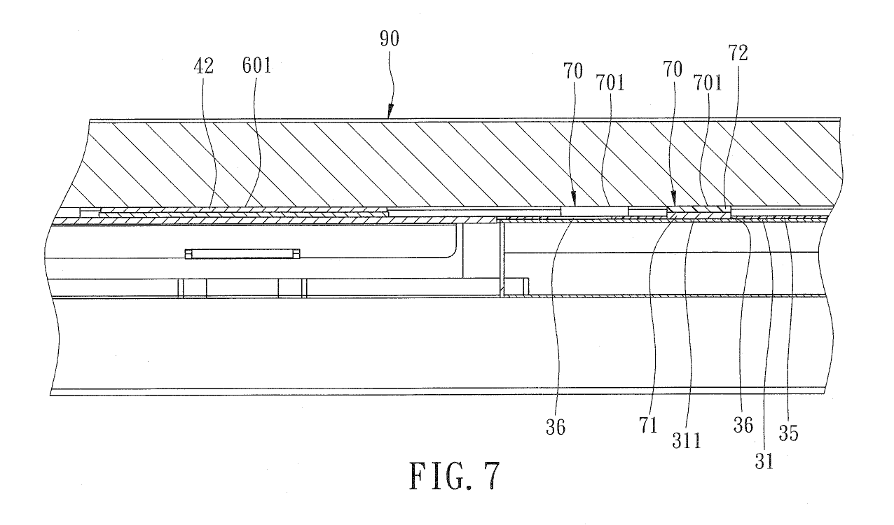

Referring to FIGS. 5 to 7, in use, the magnetic support pads 70 are disposed in selected ones of the positioning holes 36 in the positioning plate 35 at suitable positions within the positioning holes 36 depending on the configuration of the workpiece 90 so as to be magnetically attracted to the top surface 311 of the table top 31 in such a manner that the workpiece 90 can be stably supported on the top surface 311 of the table top 31. The workpiece 90 is then disposed on the first support surfaces 701 of the magnetic support pads 70 and the second support surface 601 on the connecting plate portion 42 such that only the central portion 91 of the workpiece 90 is in contact with the first and second support surfaces 701, 601, while the edge portion 92 of the workpiece 90 is not in contact with the first and second support surfaces 701, 601 and is thus suspended. Since the first and second support surfaces 601, 701 extend along the same horizontal plane (H) which is parallel to the positioning plate 35 and the top surface 311 of the table top 31, the workpiece 90 may be kept parallel with the top surface 311 of the table top 31 without tilting. The workpiece 90 can then be handled and moved manually by the operator to allow the blade 81 on the tool 80 to perform the desired machining operations, such as chamfering processing, on the edge band 93 of the workpiece 90.

In the present invention, the positioning plate 35 may be omitted. In this case, the magnetic support pads 70 are attached magnetically to the top surface 311 of the table top 31 at suitable positions on the table top 31 depending on the configuration of the workpiece 90 to provide a similar support effect.

In view of the foregoing, the worktable assembly of the present invention provides the following advantages:

With the provision of the magnetic support pads 70 for supporting the workpiece 90, the workpiece 90 can be well-supported without contacting the table top 31, allowing some local areas and the edge portion 92 of the workpiece 90 to remain suspended, thus facilitating performing of machining operations on the edge band 93. The worktable assembly of the present invention is thus suitable for use with workpieces of various configurations.

In addition, each of the magnetic support pads 70 is movable manually along the length (d1) of the respective positioning hole 36, thus enabling fine adjustment of the position of each of the magnetic support pads 70. Moreover, the magnetic support pads 70 can be easily removed from or disposed in the positioning holes 36 as desired.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A worktable assembly adapted to be disposed with a workpiece thereon comprising:
a table top having a magnetically attractive top surface; and
a workpiece support including a plurality of magnetic support pads disposed removably on and magnetically attracted to said top surface of said table top, each of said magnetic support pads having an upward first support surface for contacting the workpiece, said first support surfaces of said magnetic support pads extending along a horizontal plane when said magnetic support pads are disposed on said top surface of said table top.

2. The worktable assembly as claimed in claim 1, further comprising a positioning plate attached to said table top and disposed under said horizontal plane, said positioning plate being formed with a plurality of positioning holes, each of said magnetic support pads being disposed removably in a selected one of the positioning holes.

3. The worktable assembly as claimed in claim 2, wherein each of said magnetic support pads includes a magnet layer and an abrasion resistant layer secured to said magnet layer, said first support surface being formed on said abrasion resistant layer.

4. The worktable assembly as claimed in claim 2, wherein each of said positioning holes in said positioning plate is elongated and has a width and a length, each of said magnetic support pads having a greatest diameter smaller than the length of each of said positioning holes such that each of said magnetic support pads is movable along the length of a respective one of said positioning holes.

5. The worktable assembly as claimed in claim 4, wherein each of said magnetic support pads is circular in shape.

6. The worktable assembly as claimed in claim 1, wherein said table top is formed with a mounting cavity and a plurality of fastening blocks adjacent to said mounting cavity, said worktable assembly further comprising a mounting unit adapted for mounting with a tool, said mounting unit including a mounting plate which has a plurality of side plate portions fastened to said fastening blocks and a connecting plate portion interconnecting said side plate portions.

7. The worktable assembly as claimed in claim 6, wherein said mounting unit has an upward second support surface extending along said horizontal plane.

8. The worktable assembly as claimed in claim 7, wherein said second support surface is formed on said connecting plate portion.

9. The worktable assembly as claimed in claim 6, wherein said connecting plate portion is adapted for mounting with the tool and is formed with fastener holes, said mounting unit further including a plurality of fastening screws extending through said fastener holes and adapted for engaging the tool.
